(19) United States
(12) Patent Application Publication
(10) Pub. No.: US 2012/0242732 A1
(43) Pub. Date: Sep. 27, 2012

(54) LIQUID DISCHARGING APPARATUS

(75) Inventor: Atsushi Nagahara, Azumino-shi (JP)

(73) Assignee: SEIKO EPSON CORPORATION, Tokyo (JP)

(21) Appl. No.: 13/429,079

(22) Filed: Mar. 23, 2012

(30) Foreign Application Priority Data
Mar. 24, 2011 (JP) 2011-065395

(51) Int. Cl. B41J 29/38

(52) U.S. Cl. 347/14

(57) ABSTRACT

A liquid discharging apparatus has a dot forming section that forms a plurality of dot rows; a designation section that designates a density irregularity region having a density irregularity among the plurality of dot rows formed on the medium; a correction data creating unit that creates a plurality of correction data items of the density irregularity region designated by the designation section, the correction data being obtained by changing a gradation value of a density irregularity portion of the density irregularity region, by the use of the nozzles each corresponding to each dot row of the density irregularity region; and a selection section that selects a corrected image having a small density irregularity among a plurality of corrected images each formed on the medium by the dot forming section based on each correction data item.

### BACKGROUND

1. Technical Field

The present invention relates to a liquid discharging apparatus.

2. Related Art

As a liquid discharging apparatus, an ink jet type printer is known which discharges ink (a kind of liquid) to a medium (for example, paper) to print an image on the medium. For example, a printer is known which performs a discharging operation of discharging ink from each nozzle while moving the nozzle row, in which nozzles are arranged in a row direction, in an intersection direction intersecting the row direction, and a moving operation of moving a position of the nozzle row in the row direction during discharging operation. In such a printer, in some cases, a streaky density irregularity along the intersection direction may be seen in an image including a plurality of raster lines (a dot row arranged in the intersection direction) (for example, see JP-A-2006-264298). A cause of the density irregularity is generally due to a machining accuracy of the nozzle. Specifically, the density irregularity is also generated in a case where there is a variation of a discharging amount of ink between the nozzles, in a case where a position (a dot forming position) where ink is discharged from the nozzles to form dots on the medium is shifted from a target position or the like.

As a method of suppressing the density irregularity, there is a method of printing a correcting pattern, measuring the same by a density measuring device such as a scanner to specify a raster line of a cause of the density irregularity, and correcting the density for each raster line when performing main printing of the image.

However, even if such a correction is performed, in some cases, when actually printing the medium, the correspondence is insufficient depending on the image, and there is a location where the density irregularity is noticeable. In this manner, it is difficult to reliably suppress the density irregularity.

### SUMMARY

An advantage of some aspects of the invention is to more reliably suppress the density irregularity.

According to an aspect of the invention, there is provided a liquid discharging apparatus that includes a dot forming section which forms a plurality of dot rows, in which dots are arranged in an intersection direction intersecting a row direction, in the row direction, by performing a discharging operation of discharging liquid from each nozzle to a medium while moving a nozzle row, in which nozzles are arranged in the row direction, in the intersection direction intersecting the row direction, and a moving operation of moving of the nozzle row in the row direction during discharging operation; a designation section that designates a density irregularity region having a density irregularity among the plurality of dot rows formed on the medium; a correction data creating unit that creates a plurality of correction data items of the density irregularity region designated by the designation section, the correction data being obtained by changing a gradation value of the density irregularity portion of the density irregularity region by the use of the nozzles each corresponding to each dot row of the density irregularity region; and a selection section that selects a corrected image having a small density irregularity among a plurality of corrected images each formed on the medium by the dot forming section, based on each correction data item.

### BRIEF DESCRIPTION OF THE DRAWINGS

The invention will be described with reference to the accompanying drawings, wherein like numbers reference like elements.

FIG. 1 is a schematic cross-sectional view of a printer.

FIG. 2 is a block diagram of the printer.

FIG. 3 is a schematic diagram that shows a raster line formed in each pass.

FIG. 4 is an explanatory schematic diagram for describing a movement of a head.

FIG. 5 is an explanatory diagram that shows a configuration of a host computer side.

FIGS. 6A to 6C are explanatory diagrams of a density irregularity.

FIG. 7 is a diagram that shows a flow of a correction value acquisition process.

FIG. 8 is an explanatory diagram of an example of a correction pattern.

FIG. 9 is a graph that shows a calculation density for each raster line.

FIG. 10A is an explanatory diagram of an order of calculating a density correction value for correcting a command gradation value in regard to an i-th raster line, and FIG. 10B is an explanatory diagram of an order of calculating a density correction value for correcting a command gradation value in regard to a j-th raster line.

FIG. 11 is a diagram that shows a BRS correction table stored in a memory.

FIG. 12 is a diagram that shows a flow of a density irregularity adjustment process in the present embodiment.

FIG. 13 is a diagram that shows an image printed in a print region of a roll paper.

FIG. 14 is a diagram that shows an example of a designation screen of the density irregularity region.

FIG. 15 is an explanatory diagram of correction data.

FIG. 16 is a diagram that shows an example of a correction chart printed on the roll paper.

FIG. 17 is an explanatory diagram of a selection screen.

FIG. 18 is a diagram that shows an example of a display screen of a display device in a second embodiment.

### DESCRIPTION OF EXEMPLARY EMBODIMENTS

There is provided a liquid discharging apparatus that includes a dot forming section which forms a plurality of dot rows, in which dots are arranged in an intersection direction intersecting a row direction, in the row direction by performing a discharging operation of discharging liquid from each nozzle to a medium while moving a nozzle row, in which nozzles are arranged in the row direction, in the intersection direction intersecting the row direction, and a moving operation of moving of the nozzle row in the row direction during discharging operation; a designation section that designates a density irregularity region having a density irregularity among the plurality of dot rows formed on the medium; a correction data creating unit that creates a plurality of correction data items of the density irregularity region designated by the designation section, the correction data being obtained by changing a gradation value of the density irregularity portion of the density irregularity region by the use of the nozzles each corresponding to each dot row of the density irregularity region; and a selection section that selects a corrected image having a small density irregularity among a plurality of corrected images each formed on the medium by the dot forming section based on each correction data item.

According to the liquid discharging apparatus, it is possible to apply the correction data which reliably corrects the density irregularity generated when actually forming an image of a printing target on the medium. Thus, the density irregularity can more reliably be suppressed.

In the liquid discharging apparatus, it is preferable that the dot forming section be formed by aligning the plurality of corrected images in the intersection direction.

According to the liquid discharging apparatus, it is possible to form the plurality of corrected image by the same discharging operation.

In the liquid discharging apparatus, it is preferable that the dot forming section change a position of the row direction when aligning the plurality of corrected images in the intersection direction by moving the nozzle row in the row direction in a case where it is difficult to form the plurality of corrected images side by side in the intersection direction.

According to the liquid discharging apparatus, it is possible to form the further corrected images in the same print region.

In the liquid discharging apparatus, it is preferable that the dot forming section be formed over a plurality of pages in a case where it is difficult to form the plurality of corrected images in one page.

According to the liquid discharging apparatus, it is possible to form the further corrected images regardless of a size of the density irregularity region.

In the liquid discharging apparatus, it is preferable that the apparatus have a reading section which reads an image formed on the medium by the dot forming section, and the designation section designate the density irregularity region based on a reading result of the reading section.

According to the liquid discharging apparatus, it is possible to simply, easily and reliably perform the designation of the density irregularity region.

In the liquid discharging apparatus, it is preferable that the apparatus further include a display section which displays the image of the printing target, and the reading result of the reading section of the image printed on the medium side by side.

According to the liquid discharging apparatus, it is possible to easily discriminate the density irregularity region based on the reading result of the reading section.

In the liquid discharging apparatus, it is preferable that the apparatus has a reading section which reads the image formed on the medium by the dot forming section, and the selection section select a corrected image having a small density irregularity among the plurality of corrected images.

According to the liquid discharging apparatus, it is possible to simply, easily, and reliably select an optimal pattern.

In an embodiment described below, a printing system will be described as an example which has a lateral type ink jet printer (hereinafter, also referred to as a printer 1) as the liquid discharging apparatus and a host computer 110.

### Configuration Example of Printer 1

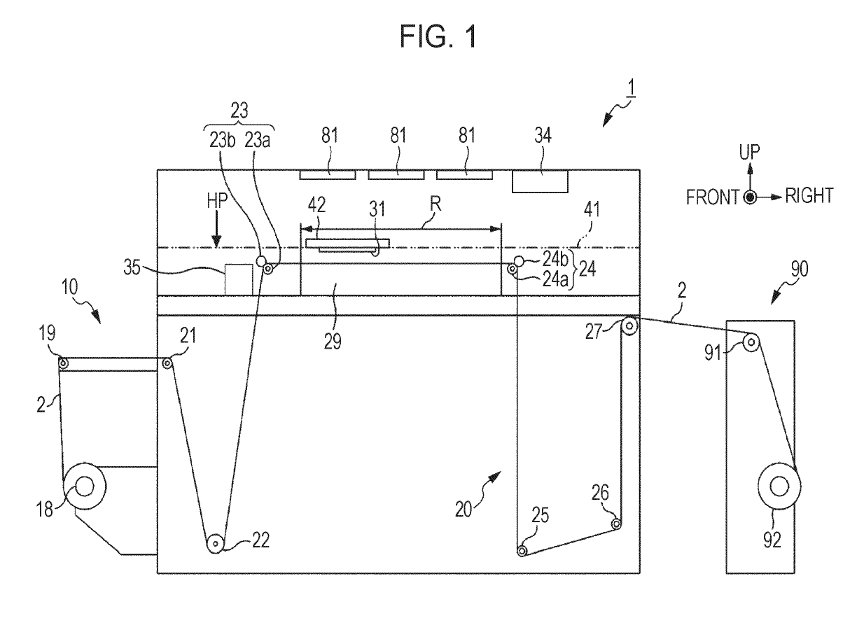

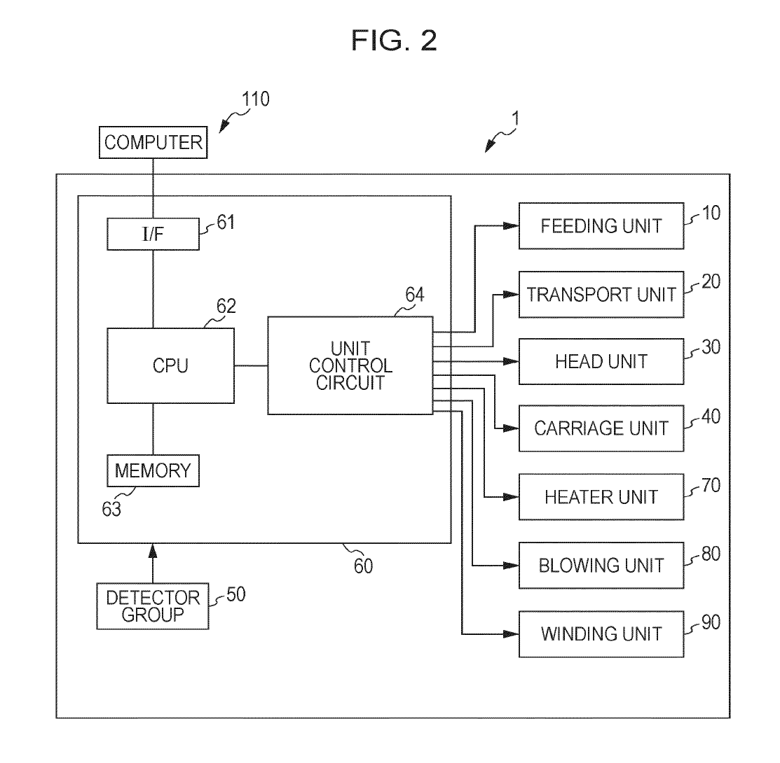

A configuration example of the printer 1 will be described by the use of FIGS. 1 and 2. FIG. 1 is a schematic cross-sectional view of the printer 1. FIG. 2 is a block diagram of the printer 1.

In addition, in the description as below, “a vertical direction” and “a longitudinal direction” are indicated on the basis of a direction indicated by an arrow in FIG. 1. Furthermore, “a transverse direction” indicates a direction perpendicular to a paper in FIG. 1.

Furthermore, in the present embodiment, a description will be made by the use of a roller paper 2 (a continuous paper) as a medium that records an image by the printer 1.

As shown in FIGS. 1 and 2, the printer 1 (corresponding to a dot forming section) according to the present embodiment has a transport unit 20, a feeding unit 10, a platen 29, and a winding unit 90 along a transport path in which the transport unit 20 transports the roll paper 2. Furthermore, the printer 1 has a head unit 30, a carriage unit 40, a cleaning unit, a flushing unit 35, a heater unit 70, a blowing unit 80, a controller 60 that controls such a unit or the like and takes charge of the operation as the printer 1, and a detector group 50.

The feeding unit 10 feeds the roll paper 2 to the transport unit 20. The feeding unit 10 has a scroll 18 around which the roll paper 2 is wound and is rotatably supported, and a relay roller 19 for winding the roller 2 unwound from the scroll 18 and guiding the same to the transport unit 20.

The transport unit 20 transports the roller paper 2 sent by the feeding unit 10 along a predetermined transport path. As shown in FIG. 1, the transport unit 20 has a relay roller 21 that is situated at a horizontal right side to the relay roller 19, a relay roller 22 that is situated at a right oblique lower side when viewed from the relay roller 21, a first transport roller 23 that is situated at a right oblique upper side (in a direction in which the roller 2 is transported, the upstream side when viewed from the platen 29) when viewed from the relay roller 22, a second transport roller 24 that is situated at the right side (in a direction in which the roller 2 is transported, the downstream side when viewed from the platen 29) when viewed from the first transport roller 23, a reverse roller 25 that is situated at the vertical lower side when viewed from the second transport roller 24, a relay roller 26 that is situated at the right side when viewed from the reverse roller 25, and a delivery roller 27 that is situated at the upper side when viewed from the relay roller 26.

The relay roller 21 is a roller that winds the roll paper 2 sent from the relay roller 19 from the left side and unwinds the same downward.

The relay roller 22 is a roller that winds the roll paper 2 sent from the relay roller 21 from the left side and transports the same to the right oblique upper side.

The first transport roller 23 has a first driving roller 23a that is driven by a motor (not shown), and a first driving roller 23b that is placed so as to face the first driving roller 23a with the roll paper 2 interposed therebetween. The first transport roller 23 is a roller that pulls up the roll paper 2, which is slackened downward, upward, and transports the roll paper 2 to the print region R facing the platen 29. The first transport roller 23 is configured to temporarily stop the transportation in a period during which the image recording is performed on a part of the roll paper 2 on the print region R (that is, as described later, the head 31 discharges ink to the part of the stopped roll paper 2 while being moved in the longitudinal direction and the transverse direction, whereby the image recording of one page is performed in the part). In addition, by the driving control of the control 60, the first driven roller 23b is rotated along with the rotation driving of the first driving roller 23a, whereby the transport amount (a length of the part of the roll paper) of the roll paper 2 situated on the platen 29 is adjusted.

As mentioned above, the transport unit 20 has a mechanism that transports the part of the roll paper 2 wound between the relay rollers 21 and 22 and the first transport roller 23 so as to be slackened downward. The slackness of the roll paper 2 is monitored based on the detection signal from a slackness detecting sensor (not shown) by a controller 60. Specifically, when the slackness detecting sensor detects the part of the roll paper 2 slackened between the relay rollers 21 and 22 and the first transport roller 23, tension of suitable magnitude is applied to the part, and thus, the transport unit 20 is able to transport the roll paper 2 in a slack state. Meanwhile, when the slackness detecting sensor does not detect the part of the slack roll paper 2, tension of excessive magnitude is applied to the part, and thus, the transportation of the roll paper 2 by the transport unit 20 is temporarily stopped, and tension is adjusted to a suitable magnitude.

The second transport roller 24 has a second driving roller 24a that is driven by a motor (not shown), and a second driven roller 24b that is placed so as to face the second driving roller 24a with the roll paper 2 interposed therebetween. The second transport roller 24 is a roller that transports the part of the roll paper 2 after the image is recorded by the head unit 30 in a horizontal right direction along a support surface of the platen 29, and then transports the same to the vertical lower side. As a result, the transport direction of the roll paper 2 is converted. In addition, by the driving control of the controller 60, the second driven roller 24b is rotated along with the rotation driving of the second driving roller 24a, whereby a predetermined tension applied to the part of the roll paper 2 situated on the platen 29 is adjusted.

The reverse roller 25 is a roller that winds the roll paper 2 sent from the second transport roller 24 from the left upper side and transports the roll paper 2 toward the right oblique upper side.

The relay roller 26 is a roller that winds the roll paper 2 sent from the reverse roller 25 from the left lower side and transports the roll paper 2 upward.

The delivery roller 27 is a roller that winds the roll paper 2 sent from the relay roller 26 from the left lower side and sends the roll paper 2 winding unit 90.

In this manner, the roll paper 2 is sequentially moved via the respective rollers, whereby the transport path for transporting the roll paper 2 is formed. In addition, the roll paper 2 is intermittently transported along the transport path in the unit of the region corresponding to the print region R by the transport unit 20 (that is, the intermittent transport is performed whenever the image recording of one page is performed in the part of the roll paper 2 on the print region R).

The head unit 30 discharges ink as an example of liquid to a part of the roll paper 2 transported to the print region R (on the platen 29) on the transport path by the transport unit 20. The head unit 30 has a head 31 and a valve unit 34.

The head 31 has a nozzle row, in which nozzles are arranged in the row direction, on a lower surface thereof. In the present embodiment, the head 31 has the nozzle rows that include a plurality of nozzles #1 to #N for each color such as yellow (Y), magenta (M), cyan (C), and black (K). The respective nozzles #1 to #N of the respective nozzle rows are arranged in a straight line shape in a direction (a row direction) intersecting the transport direction of the roll paper 2. The respective nozzle rows are placed in parallel so as to be separated from each other.

The respective nozzles #1 to #N are provided with piezoelectric elements (not shown) as driving element for discharging the ink droplets. The piezoelectric element is stretched depending on the application time of the voltage when applying the voltage of a predetermined time width between the electrodes provided in both ends thereof, thereby deforming the wide wall of the flow path of ink. As a result, the volume of flow path of ink is contracted depending on the expansion and contraction of the piezoelectric element, and ink corresponding to the contraction becomes the ink droplet and is discharged from the respective nozzles #1 to #N of each color.

Furthermore, as described later, the head 31 is able to reciprocate in the transport direction (that is, the longitudinal direction) and in the row direction (that is, the transverse direction).

The valve unit 34 temporarily stores ink and is connected to the head 31 via an ink supplying tube (not shown). For this reason, the head 31 is able to perform the image recording, by discharging ink supplied from the valve unit 34 toward the part of the roll paper 2 of the state of being transported from the nozzles onto the platen 29 and being stopped.

The carriage unit 40 moves the head 31. The carriage unit 40 has a carriage guide rail 41 (indicated by a two-dot chain line in FIG. 1) extending in the transport direction (the longitudinal direction), a carriage 42 that is supported so as to be movable in a reciprocating manner in the transport direction (the longitudinal direction) along the carriage guide rail 41, and a motor (not shown).

The carriage 42 is configured so as to be moved in the transport direction (the longitudinal direction) integrally with the head 31 by the driving of the motor (not shown). Furthermore, the carriage 42 is provided with a head guide rail (not shown) that is extended in the row direction (the transverse direction), and the head 31 is configured so as to be moved in the row direction (the transverse direction) along the head guide rail.

A cleaning unit (not shown) cleans the head 31. The cleaning unit is provided in a home position (hereinafter, referred to as HP, see FIG. 1), and has a cap, a suction pump or the like. When the head 31 (the carriage 42) is moved in the transport direction (the longitudinal direction) and is situated in the HP, a cap (not shown) comes close-contact with a lower surface (the nozzle surface) of the head 31. In this manner, when the suction pump is operated in the state where the cap comes into close-contact with head, ink in the head 31 is sucked together with the thickened ink and the paper dust. In this manner, the clogged nozzle is recovered from the non-discharging state, whereby the cleaning of the head is completed.

Furthermore, a flushing unit 35 is provided between the HP and the platen 29 in the transport direction (the longitudinal direction). When the head 31 (the carriage 42) is moved in the transport direction (the longitudinal direction) and is situated in a position (hereinafter, referred to as a flushing position) facing the flushing unit 35, the head 31 executes a flushing operation of discharging ink from each nozzle belonging to the nozzle row to perform the flushing.

The platen 29 supports the part of the roll paper 2 situated in the print region R on the transport path and heats the part. As shown in FIG. 1, the platen 29 is provided corresponding to the print region R on the transport path, and is placed in a region along the transport path between the first transport roller 23 and the second transport roller 24. Moreover, the platen 29 is able to heat the part of the roll paper 2 by being supplied with head generated by the heater unit 70.

The heater unit 70 heats the roll paper 2, and has a heater (not shown). The heater has a nichrome wire, and is configured so as to place the nichrome wire at a certain distance from the support surface of the platen 29 within the platen 29. For this reason, the heater is supplied with electricity, whereby the nichrome wire itself is heated, whereby it is possible to conduct the heat to the part of the roll paper 2 situated on the support surface of the platen 29. The heater is configured by equipping the nichrome wire over the whole area of the platen 29, and thus, it is possible to uniformly conduct the heat to the part of the roll paper 2 on the platen 29. In the present embodiment, the part of the roll paper 2 is uniformly heated so that the temperature of the part of the roll paper 2 on the platen becomes 45° C. As a result, it is possible to dry ink laded in a part of the roll paper 2.

The blowing unit 80 sends the airflow to the roll paper 2 on the platen 29. The blowing unit 80 includes a fan 81, and a motor (not shown) for rotating the fan 81. The fan 81 sends the airflow to the roll paper 2 on the platen 29 by being rotated, thereby drying the ink landed on the roll paper 2. As shown in FIG. 1, a plurality of fans 81 is provided in an openable and closeable cover (not shown) provided in a main body section. Moreover, the respective fans 81 are situated above the platen 29 when closing the cover, and face the support surface (the roll paper 2 on the platen 29) of the platen 29.

The winding unit 90 winds the roll paper 2 (the roll paper subjected to the image recording) sent by the transport unit 20. The winding unit 90 includes a relay roller 91 for winding the roll paper 2 sent from the delivery roller 27 from the left upper side and transporting the same to the right oblique lower side, and a driving shaft 92 that is rotatably supported and winds the roll paper 2 sent from the relay roller 91.

The controller 60 is a control unit for controlling the printer 1. As shown in FIG. 2, the controller 60 has an interface section 61, a CPU 62, a memory 63, and a unit control circuit 64. The interface section 61 transmits and receives data between the host computer 110 as an external device and the printer 1. The CPU 62 is an arithmetic processing device for controlling the entire printer 1. The memory 63 ensures a region storing a program of the CPU 62, a working region or the like. The CPU 62 controls the respective units by the unit control circuit 64 according to the program stored in the memory 63.

The detector group 50 monitors the situation in the printer 1, and includes, for example, a rotary type encoder that is mounted on the transport roller and is used for controlling the transportation or the like of the medium, a paper detection sensor that detects the presence or the absence of the medium to be transported, a linear type encoder for detecting the position of the transport direction (the longitudinal direction) of the carriage 42 (or the head 31) or the like.

### Operation Example of Printer 1

As mentioned above, the printer 1 according to the present embodiment is provided with the head 31 having the nozzle row with the nozzles arranged in the row direction (the transverse direction). Moreover, the controller 60 discharges ink from the nozzles while moving the head 31 in the transport direction (the longitudinal direction), and forms the raster line along the transport direction (the longitudinal direction), thereby recording the image of one page in the part of the roll paper 2 on the print region R.

Herein, the controller 60 according to the present embodiment executes the printing of a multi-pass (6 passes, 8 passes, 16 passes or the like). That is, in order to increase the resolution of the image in the row direction, the position of the head 31 in the row direction is gradually changed for each pass to perform the printing. Furthermore, as the image forming method, for example, a known interlace (micro-weave) printing is executed.

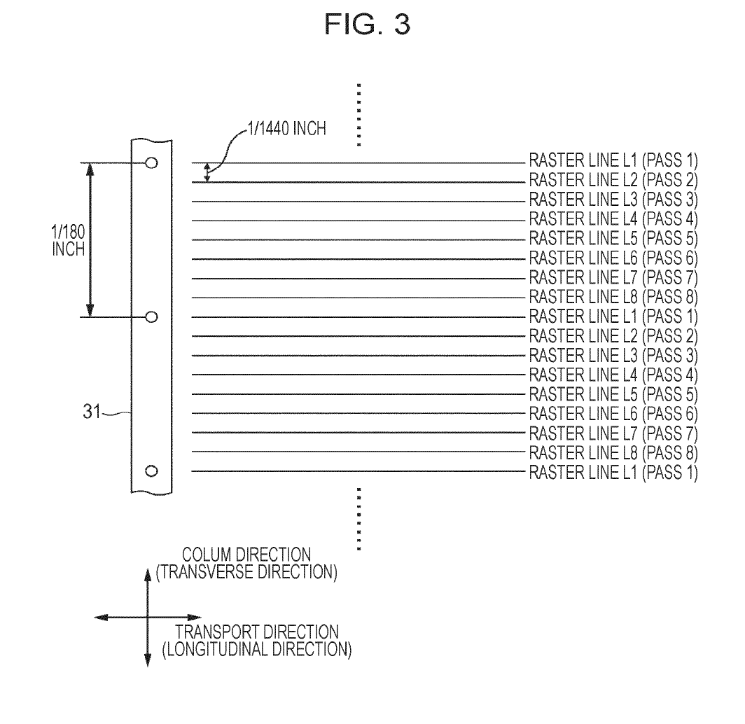

This will specifically be described by the use of FIG. 3. FIG. 3 is a schematic diagram that shows the raster line formed in each pass in a case of printing by 8 passes.

The nozzle row (the nozzles) of the head 31 is indicated at the left side of FIG. 3, and ink is discharged from the nozzles while the head 31 (the nozzle row) is moved in the transport direction, whereby the raster line is formed. A position of the head 31 (the nozzle row) in the row direction shown in FIG. 3 is a position of a first pass. When the head 31 (the nozzle row) is moved in the transport direction while maintaining the position, the printing of the first page is executed, and three raster lines (raster lines L1 written as pass 1 in the right end) shown in FIG. 3 are formed.

Moreover, next, when the head 31 (the nozzle row) is moved in the row direction and the head 31 (the nozzle row) is moved in the transport direction while maintaining the position after the movement, the printing of the second pass is executed, and two raster lines (raster lines L2 written as pass 2 in the right end) shown in FIG. 3 are formed. In addition, since the interlace (micro-weave) printing is adopted, the raster line L2 adjacent to the raster line L1 is formed by ink that is discharged from the nozzle different from the nozzle from which ink forming the raster line L1 is discharged. For that reason, the movement distance of the head 31 (the nozzle row) in the row direction is not ⅛ ( 1/180×⅛= 1/1,440 inches) of a distance between the nozzles (for example, 1/180 inches) but is a distance greater than that (hereinafter, referred to as a distance d).

After that, the same operation is executed, whereby the printing of the third to eighth passes, and the remaining raster lines (rater lines L3 to L8 written as passes 3 to 8 in the right end) shown in FIG. 3 are formed. In this manner, the raster line is formed by 8 passes, whereby it is possible to set the resolution of the image in the row direction to the resolution of 8 times (=1,440 180).

In addition, in the present embodiment, a so-called a bidirectional printing is performed. That is, the movement direction of the head 31 (the nozzle row) when the printing of the first pass, the third pass, the fifth pass, and the seventh pass are performed is opposite to the movement direction of the head 31 (the nozzle row) when the printing of the second pass, the fourth pass, the sixth pass, and the eighth pass are performed (described in detail later).

Hereinafter, the image recording operation (in other word, an operation when forming the dot in the print region R) of the printer 1 as an operation example of the printer 1 will be described. However, the case of FIG. 3 printed by the 8 pass mentioned above will be described as an example (in the description below, also sees FIG. 3 at any time). Furthermore, in order to facilitate the description, the description will be made so that the number (not multiple) of nozzle row is one. Furthermore, in the present embodiment, as described later, flushing operation is executed between the image recording operations.

### Image Recording Operation and Flushing Operation of Printer 1

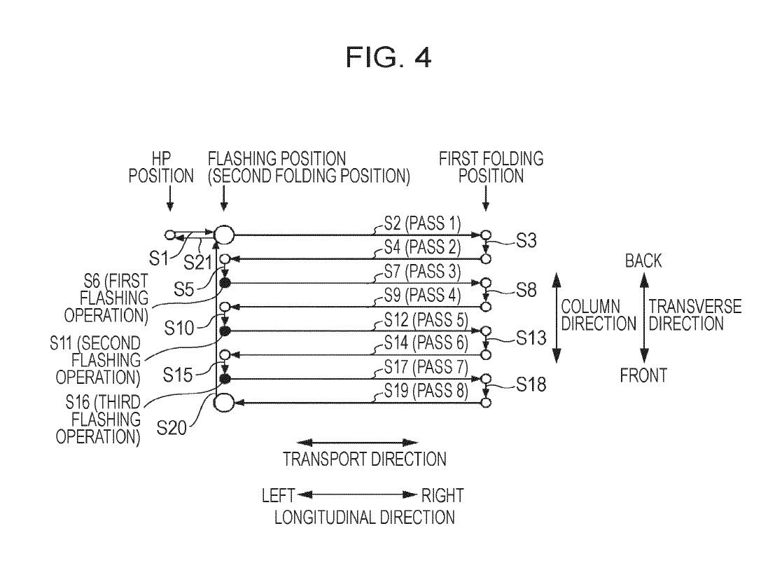

Herein, an image recording operation example of the printer 1 and a flushing operation example to be executed between the image recording operations will be described by the use of FIGS. 3 and 4. FIG. 4 is an explanatory schematic diagram for describing the movement of the head 31. (Viewpoint of) FIG. 4 will firstly be described before describing the image recording operation and the flushing operation.

FIG. 4 shows how the head 31 is moved while the printing process (that is, a series of processes relating to the image recording and the flushing) is performed. The head 31 is indicated by circles for convenience (a large circle and a small circle are present in the drawings, there is no meaningful distinction between both of them), and the movement of the head 31 is indicated by an arrow. Herein, an arrow pointing in the longitudinal direction in FIG. 4 indicates the movement of the head 31 in the transport direction, and an arrow pointing in the vertical direction indicates the movement of the head 31 in the row direction. Furthermore, the respective arrows are denoted by reference numerals S1 to S21, but those are step numbers that are used in the description of the printing process after that.

Furthermore, there are step numbers denoted by the pass 1 to pass 8, but the step numbers indicate the steps in which the image recording operation is executed by the discharging of ink.

Furthermore, a white circle and a black circle exist in the circle situated in the flushing position, but the black circle means that the flushing operation is performed (on the contrary, the white circle means that the flushing is not performed). The black circles are denoted by reference numerals of S6, S11, and S16, but those are step numbers used in the description of the printing process after that.

Hereinafter, the printing process will be described with reference to FIGS. 3 and 4. In addition, the printing process is realized mainly by the controller 60. Particularly, in the present embodiment, the printing process is realized by the processing of the program stored in the memory 63 by the CPU 62. Moreover, the program is constituted by codes for performing various operations described later.

When the intermittent transportation of the roll paper 2 mentioned above is performed and the roll paper 2 is stopped, the printing process for performing the image recording of one page in the part of the roll paper 2 on the print region R is started.

Firstly, the controller 60 moves the head 31 from the HP position in an outward direction (a direction facing from the upstream side to the downstream side in the direction in which the roll paper 2 is transported) (step S1).

Next, when the head 31 passes through the flushing position mentioned above (at this time, the flushing operation is not executed), the controller 60 discharges ink to the head 31 while causing the head 31 to continuously be moved in a forward direction, and executes the printing of the first pass (step S2). Moreover, as a result, the raster line L1 (the raster line of pass 1) shown in FIG. 3 is formed.

When the head 31 reaches a first folding position, the controller 60 moves the head 31 in the row direction (step S3). In the present embodiment, the head 31 is moved by the distance d.

After that, the controller 60 discharges ink to the head 31 while moving the head 31 in a backward direction (a direction facing from the downstream side to the upstream side in a direction in which the roll paper 2 is transported), and executes the printing of the second pass (step S4). Moreover, as a result, the raster line L2 (the raster line of pass 2) shown in FIG. 3 is formed.

When the head 31 reaches the flushing position (this position is also a second folding position), the controller 60 moves the head 31 in the row direction (step S5). In the present embodiment, the head 31 is moved by the distance d.

Moreover, when the movement is completed, the controller 60 causes the head 31 to execute the flushing operation (a first flushing operation) of discharging the ink from the respective nozzles belonging to the nozzle row to perform the flushing (step S6).

Next, the controller 60 furthermore performs the same process as those of the step S2 to step S6 twice (step S7 to step S11, and step S12 to step S16). In the first process, the raster line L3 (the raster line of pass 3) shown in FIG. 3 is formed by the printing (step S7) of the third pass, and the raster line L4 (the raster line of pass 4) shown in FIG. 3 is formed by the printing (step S9) of the fourthpass, respectively. Furthermore, the flushing operation (the second flushing operation, step S11) is also executed.

Furthermore, by the second process, the raster line L5 (the raster line of pass 5) shown in FIG. 3 is performed by the printing (step S12) of the fifth pass, and the raster line L6 (the raster line of pass 6) shown in FIG. 3 is formed by the printing (step S14) of the sixth pass, respectively. Furthermore, the flushing operation (the third flushing operation, step S16) is also executed.

Next, the controller 60 executes the printing of the final two passes. That is, the controller 60 discharges the ink to the head 31 while moving the head 31 in the forward direction and executes the printing the seventh pass (step S17). Moreover, as a result, the raster line L7 (the raster line of pass 7) shown in FIG. 3 is formed. When the head 31 reaches the first folding position, the controller 60 moves the head 31 in the row direction (step S18). In the present embodiment, the head 31 is moved by the distance d. After that, the controller 60 discharges the ink to the head 31 while moving the head 31 in the backward direction, and executes the printing of the eighth pass (step S19). Moreover, as a result, the raster line L8 (the raster line of pass 8) shown in FIG. 3 is formed.

When the head 31 reaches the flushing position (at this time, the flushing operation is not executed), the controller 60 returns the position of the head 31 in the row direction to an original position (step S20). That is, the head 31 is moved by a distance 7d in a direction opposite to the direction in which the head 31 is moved in steps S3, S5, S8, S10, S13, S15, and S18.

Moreover, the controller 60 finishes the printing process of one page by moving the head 31 from the flushing position to the HP position (step S21).

### Configuration of Host Computer Side

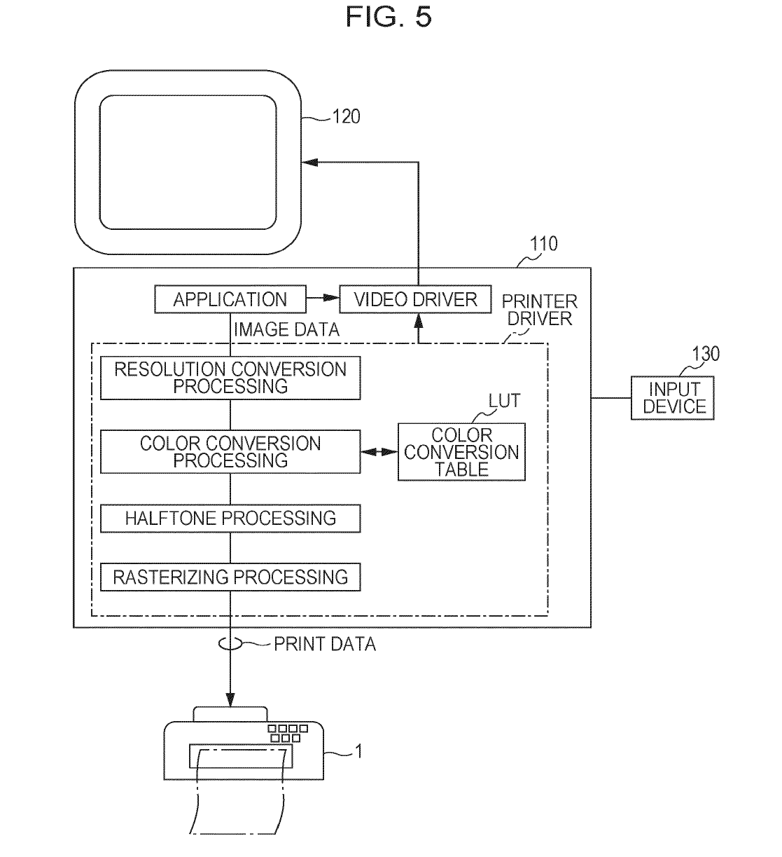

FIG. 5 is an explanatory diagram that shows a configuration of the host computer 110 side. The host computer 110 includes a display device 120, and an input device 130. Furthermore, the host computer 110 is connected to the printer 1 in a communicable manner, and outputs the print data depending on the image to the printer 1 so as to print the image in the printer 1. The display device 120 has a display, and displays a use interface such as an application program and a printer drive. The input device 130 is, for example, a keyboard and a mouse, and is used in the operation of the application program, the setting the printer driver or the like according to the user interface displayed on the display device 120. Furthermore, in the present embodiment, the input device 130 corresponds to an instruction section and a selection section.

The printer driver is installed to the host computer 110. The printer driver is a program for causing the display device 120 to realize a function of converting the image data, which is output from the application program, into the printing data, in addition to a function of displaying the user interface. The printer driver is recorded on a recording medium (a recording medium that is readable by a computer) such as a flexible disk FD and a CD-ROM. Otherwise, it is also possible to download the printer driver to the computer 1100 via an internet. In addition, the program is constituted by codes for realizing various functions.

In addition, the “printing apparatus (the liquid discharging apparatus)” means the printer 1 in a narrow sense, but means a system of the printer 1 and the host computer 110 in a wide sense. Furthermore, in the present embodiment, the printer 1 is separated from the host computer 110, but the respect parts thereof may be integrally configured.

### Printer Driver

Next, a basic process performed by the printer driver will be described.

In the host computer 110, computer programs such as a video driver, an application program, and a printer driver are operated under the mounted operating system. The video driver has, for example, a function of displaying the user interface or the like on the display device 120 according to the display command from the application program and the printer driver. The application program has, for example, a function of performing an image edition or the like, and makes the data (the image data) concerning the image. A user can give an instruction which prints the image edited by the application program via the user interface of the application program. The application program outputs the image data to the printer driver when receiving the instruction of the printing.

The printer driver receives the image data from the application program, converts the image data into the printing data, and outputs the printing data to the printer 1. The image data has pixel data as data concerning pixels of the image to be printed. Moreover, the gradation value or the like of the pixel data is converted depending on the steps of each process described later, and, finally, in the step of the printing data, the pixel data is converted into the data (data of color, size or the like of the dot) concerning the dot formed on the paper. In addition, the pixel is a grid-like square that is virtually defined on the paper so as to define the position in which the ink is landed to form the dot.

The printing data is data of a form that can be interpreted by the printer 1, and is data that has the pixel data and various command data. The command data is data for instructing the printer 1 to execute a particular operation, and is data indicating, for example, a transport amount.

The printer driver performs a resolution conversion process, a color conversion process, a halftone process, a rasterization process or the like so as to convert the image data output from the application program into the printing data. The various processes performed by the printer driver will be described later.

The resolution conversion process is a process of converting the image data (a text data, an image data or the like) output from the application program into the resolution (an interval of the dot when printing, also referred to as a printing resolution hereinafter) when printing the image on the paper. For example, when the printing resolution is specified to 720×720 dpi, the image data received from the application program 1104 is converted into the image data of the resolution of 720×720 dpi. As the converting method, for example, when the resolution of the image data is lower than the specified printing resolution, a linear interpolation or the like is performed to generate a new pixel data is generated between the adjacent pixel data. On the contrary, when the resolution of the image data is higher than the printing resolution, the resolution of the image data is arranged to the printing data by thinning out the pixel data at a regular rate. In addition, each pixel data in the image data is data having the gradation value of the multistep (for example, 256 steps) indicated by the RGB color space. Hereinafter, the pixel data having the gradation value of RGB is called RGB pixel data, and the image data constituted by the RGB pixel data is called RGB image data.

The color conversion process is a process of converting each RGB pixel data of the RGB image data into the data having the gradation values of the multistep (for example, 256 steps) indicated by the CMYK color space. The CMYK are colors of ink included in the printer 1. Hereinafter, the pixel data having the gradation values of the CMYK are called the CMYK pixel data, and the image data constituted by the CMYK pixel data are called the CMYK image data. The printer driver refers to a table (a color conversion lookup table LUT) in which the gradation values of RGB correspond to the gradation values of CMYK, whereby the color conversion process is performed.

The halftone process is a process of converting the CMYK pixel data having the gradation values of the multistep into the CMYK pixel data having the gradation value of the small step that can be represented by the printer 1. For example, by the halftone process, the CMYK pixel data indicating the gradation value of 256 steps are converted into the CMYK pixel data of 2 bits indicating the gradation values of four steps. The CMYK pixel data of 2 bits are data that indicate, for example, “the dot is not formed” “a small dot is formed”, “a middle dot is formed”, and “a large dot is formed”. For example, a dither method or the like is used in such a halftone process, and the CMYK pixel data of 2 bits capable of being formed by the dispersion of the dot by the printer 1 are generated. In addition, the method used in the halftone process is not limited to the dither method, but a y correction method, an error diffusion method or the like may be used.

The rasterization process is a process of changing the CMYK image data subjected to the halftone process in a data order to be transmitted to the printer 1. The data subjected to the rasterization process is output to the printer 1 as the printing data.

### Suppression of Density Irregularity

Next, the density irregularity generated in the image to be printed using the printer 1 and a method of suppressing the density irregularity will be described.

For the following description, “the pixel region” and the “raster line region” are set. The pixel region refers to a region of a rectangular shape virtually defined on the medium, and the size and the shape thereof are defined depending on the printing resolution. Moreover, one “pixel” constituting the image data corresponds to one pixel region. Furthermore, “the raster line region” is a region on the medium constituted by a plurality of pixel regions arranged in the transport direction. “The pixel row” with the pixels arranged in a direction facing the transport direction on the data corresponds to one raster line.

### Density Irregularity

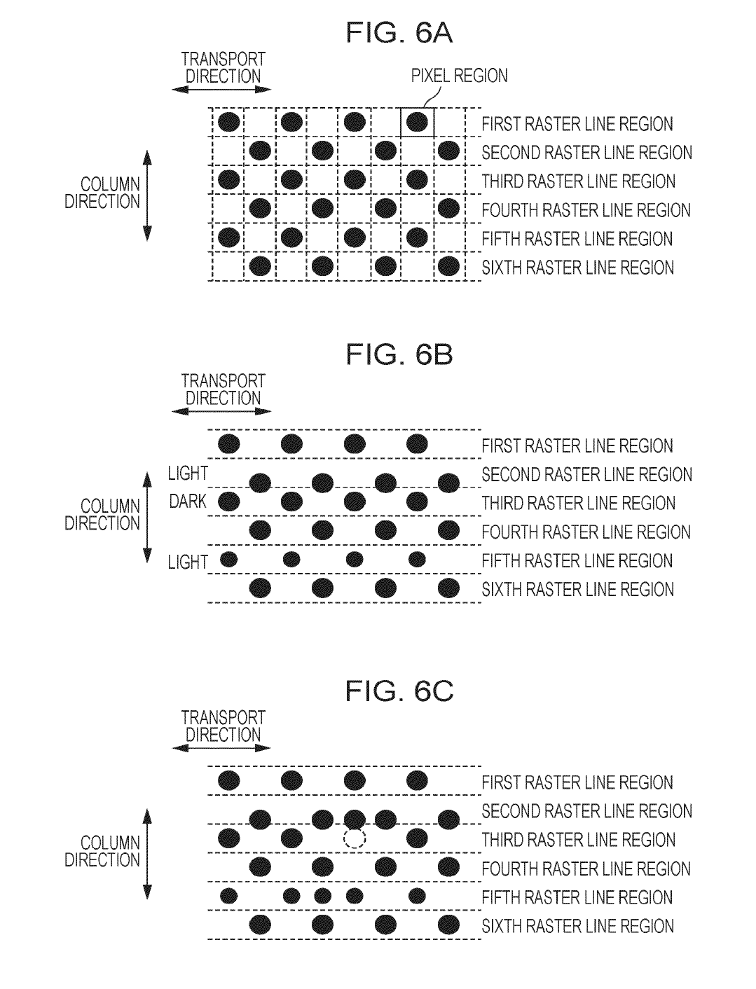

Firstly, the density irregularity will be described with reference to the drawings. FIG. 6A is an explanatory diagram when the dot is ideally formed. The expression “the dot is ideally formed” means that the ink droplet is landed in a center position of the pixel region, the ink droplet spreads on the medium, and the dots are formed in the pixel region. When each dot is correctly formed in each pixel region, the raster line (the dot row with the dots arranged in the transport direction) is correctly formed in the raster line region.

FIG. 6B is an explanatory diagram when the density irregularity is generated. The raster line formed in the second raster line region is formed near the third raster line region side by a deviation of the flying direction of the ink droplet discharged from the nozzles. As a consequence, the second raster line region becomes dim, and the third raster line region becomes dark. Furthermore, the ink amount of the ink droplet discharged to the fifth raster line region is smaller than a defined ink amount, and the dots formed in the fifth raster line region becomes smaller. Consequentially, the fifth raster line region becomes dim.

In this manner, when macroscopically viewing the printing image formed of the raster lines having the different shades, a banded-density irregularity along the transport direction is visible. The density irregularity becomes a cause that degrades the image quality of the printing image.

### Method of Suppressing Density Irregularity

As a measure for suppressing the density irregularity as mentioned above, it is considered to correct the gradation value (the command gradation value) of the image data. That is, in regard to the raster line region which is liable to be visible darkly (dimly), the gradation value of the pixel data corresponding to the unit region constituting the raster line region may be corrected so that the raster line region is formed dimly (darkly). For this reason, the density correction value H is calculated in which the gradation value of the pixel data is corrected for each raster line. The density correction value H is a value that reflects the density irregularity characteristics of the printer 1.

If the density correction value H for each raster line is calculated, a process is performed which corrects the gradation value of the pixel data for each raster line based on the density correction value H by the printer driver when executing the halftone process mentioned above. When each raster line is formed by the gradation value corrected by the correction process, the density of the raster line is corrected. As a consequence, as shown in FIG. 6C, an occurrence of the density irregularity in the printing image is suppressed. FIG. 6C is a diagram that shows a situation where the occurrence of the density irregularity is suppressed.

For example, in FIG. 6C, the gradation value of the pixel data of the pixel corresponding the respective raster line regions is corrected so that the dot generation rate of the second and fifth raster line regions visible dimly is high, and the dot generation rate of the third raster line region visible darkly is low. In this manner, the dot generation rate of the raster line of the respective raster line regions is changed, whereby the density of the single image of the raster line region is corrected, and the density irregularity of the entire printing image is suppressed.

### Calculation of Density Correction Value H

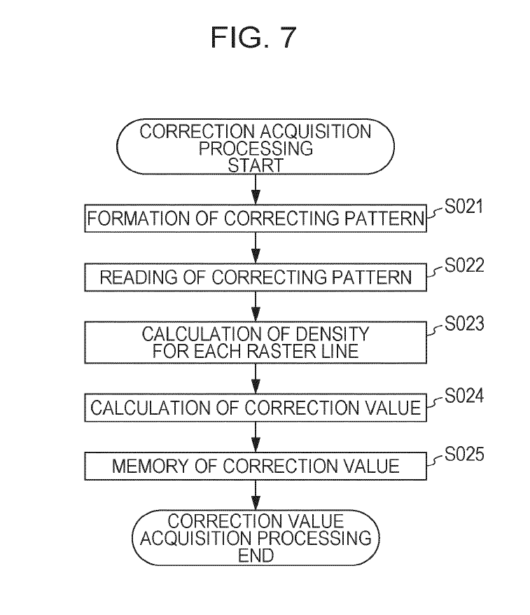

FIG. 7 is a diagram that shows a flow of a correction value acquisition process. In addition, in the case of targeting the printer 1 capable of performing the multicolor printing like the present embodiment, the correction value acquisition process of each ink color is performed by the same sequence. In the description as below, a correction value acquisition process of one ink color (for example, yellow) will be described.

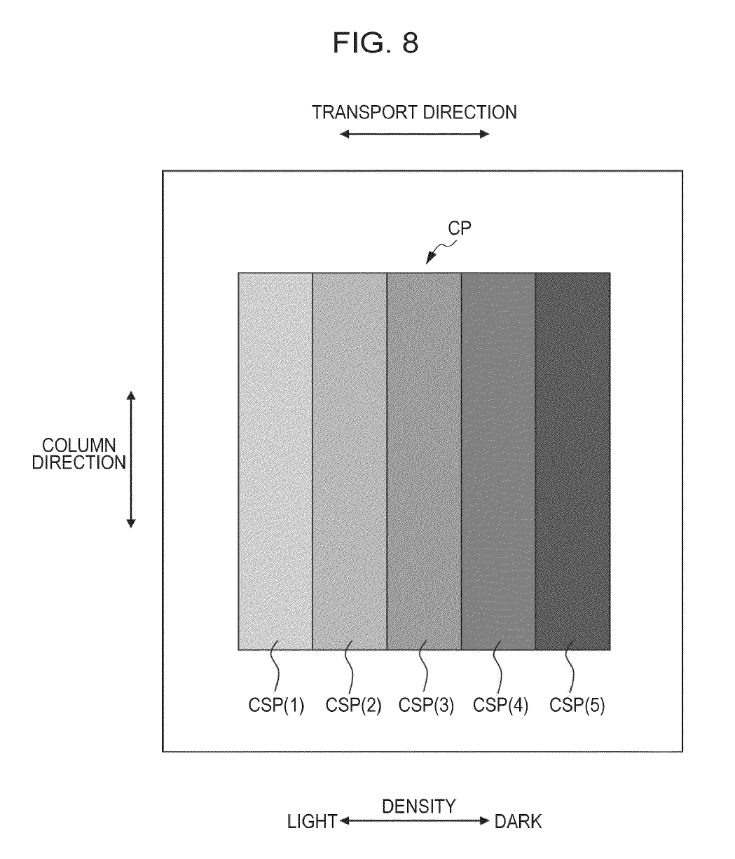

Firstly, the host computer 110 transmits the print data of the correcting pattern to the printer 1, and the printer 1 forms the correcting pattern CP on the medium (S021). As shown in FIG. 8, the correcting pattern CP is formed by five types of sub patterns CSP. In addition, FIG. 8 is an explanatory diagram of an example of the correcting pattern CP.

Each respective sub pattern CSP is a band-like pattern, and is constituted by a configuration in which a plurality of raster lines along the transport direction is arranged in the row direction. Furthermore, the respective sub patterns CSP are generated from the image data of the regular gradation value (the command gradation value), respectively. As shown in FIG. 8, the density thereof sequentially becomes dark from the left sub pattern CSP. The command gradation values of the respective sub patterns CSP are sequentially written as Sa, Sb, Sc, Sd, and Se (Sa<Sb<Sc<Sd<Se) from left. Moreover, for example, as shown in FIG. 8, the sub pattern CSP formed in the command gradation value Sa is written as CSP (1). Similarly, the sub patterns CSP formed in the command gradation values Sb, Sc, Sd, and Se are written as CSP (2), CSP (3), CSP (4), and CSP (5), respectively.

Next, the host computer 110 causes a scanner (not shown) to read the correcting pattern CP and acquires the result (S022). The scanner has three sensors corresponding to R (red), G (green), and B (blue), irradiates the correcting pattern CP with light, and detects the reflected light by the respective sensors.

Next, the host computer 110 calculates the density of the raster line of the respective sub patterns CSP based on the reading gradation value acquired by the scanner (S023). Hereinafter, the density calculated based on the reading gradation value is referred to as a calculation density.

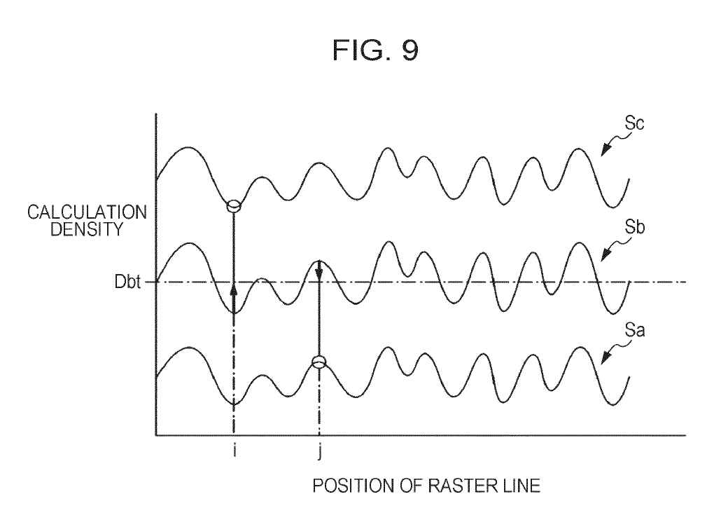

FIG. 9 is a graph that shows the calculation density for each raster line in regard to the sub pattern CSP having the command gradation values of Sa, Sb, and Sc. A horizontal axis of FIG. 9 indicates the position of the raster line, and a vertical axis thereof indicates the magnitude of the calculation density. As shown in FIG. 9, although the respective sub patterns CSP are formed by the same command gradation value, respectively, light and shade are generated in the raster line. A light and shade difference of the raster line is a cause of the density irregularity of the printing image.

Next, the host computer 110 calculates the density correction value H of the respective raster line (S024). In addition, the density correction value H is calculated for each command gradation. Hereinafter, the density correction values H calculated for the command gradations Sa, Sb, Sc, Sd, and Se are referred to as Ha, Hb, Hc, Hd, and He, respectively. In order to describe the calculation order of the density correction values H, an order will be described as an example which calculates the density correction value Hb for correcting the command gradation value Sb so that the calculation density of the raster line of the sub pattern CSP (2) of the command gradation value Sb is constant. In the order, for example, an average value Dbt of the calculation density of the entire raster line in the sub pattern CSP (2) of the command gradation value Sb is defined as a target density of the command gradation value Sb. In FIG. 9, in an i-th raster line in which the calculation density is dimmer than the target density Dbt, the command gradation value Sb may be corrected darkly. Meanwhile, in a j-th raster line in which the calculation density is darker than the target density Dbt, the command gradation value Sb may be corrected dimly.

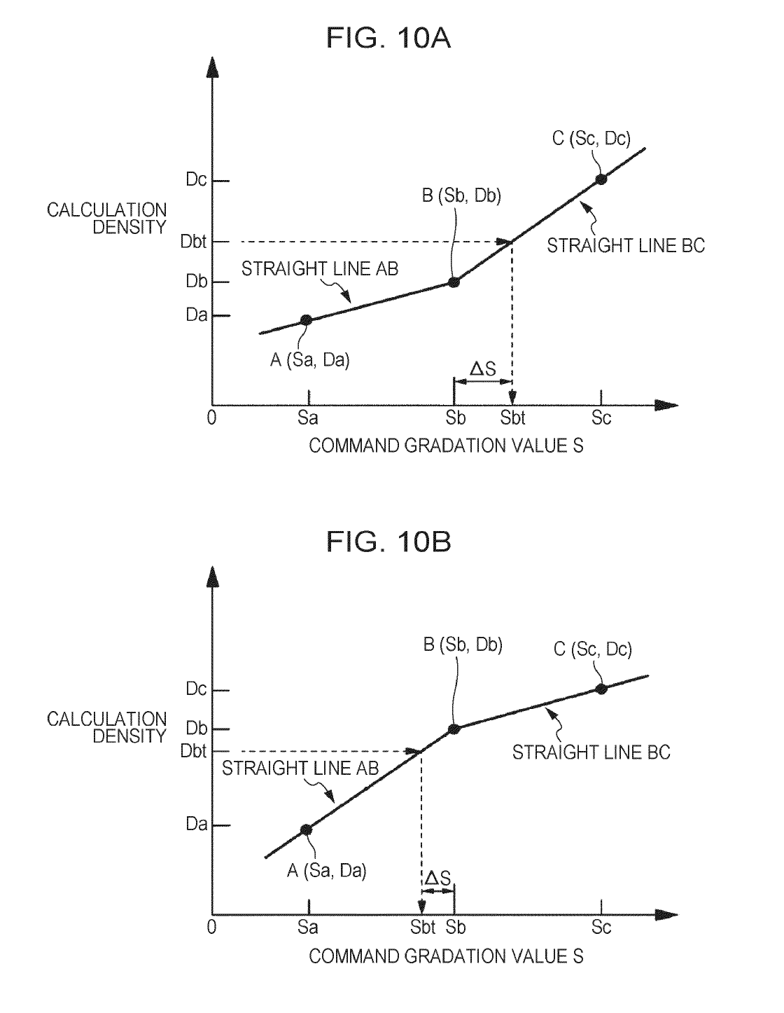

FIG. 10A is an explanatory diagram of an order of calculating the density correction value Hb for correcting the command gradation value Sb in the i-th raster line. Furthermore, FIG. 10B is an explanatory diagram of an order of calculating the density correction value Hb for correcting the command gradation value Sb in the j-th raster line. The horizontal axes of FIGS. 10A and 10B indicate the magnitude of the command gradation value, and the vertical axes thereof indicate the calculation density.

The density correction value Hb of the command gradation value Sb of the i-th raster line is calculated based on a calculation density Db of the i-th raster line in the sub pattern CSP (2) of the command gradation value Sb shown in FIG. 10A, and a calculation density Dc of the i-th raster line in the sub pattern CSP (3) of the command gradation value Sc. More specifically, in the sub pattern CSP (2) of the command gradation value Sb, the calculation density Db of the i-th raster line is smaller than the target density Dbt. In other words, the density of the i-th raster line is dimmer than the average density. If one wants to form the i-th raster line so that the calculation density Db of the i-th raster line is equal to the target density Dbt, as shown in FIG. 10A, the gradation value of the pixel data corresponding to the i-th raster line, that is, the command gradation value Sb may be corrected up to a target command gradation value Sbt calculated by formula (1) as below by the use of a straight line approximation from a correspondence (Sb, Db), (Sc, Dc) between the command gradation value and the calculation density in the i-th raster line.

Sbt=Sb+(Sc−Sb)×{(Dbt−Db)/(Dc−Db)} (1)

Moreover, from the command gradation value Sb and the target command gradation value Sbt, the density correction value H for correcting the command gradation value Sb in regard to the i-th raster line is obtained by formula (2) as below.

Hb=ΔS/Sb=(Sbt−Sb)/Sb (2)

Meanwhile, the density correction value Hb of the command gradation value Sb of the j-th rater line is calculated based on a calculation density Db of the j-th raster line in the sub pattern CSP (2) of the command gradation value Sb shown in FIG. 14B, and a calculation density Da of the j-th raster line in the sub pattern CSP (1) of the command gradation value Sa. Specifically, in the sub pattern CSP (2) of the command gradation value Sb, the calculation density Db of the j-th raster line is greater than the target density Dbt. If one wants to form the j-th raster line so that the calculation density Db of the j-th raster line is equal to the target density Dbt, as shown in FIG. 10B, the command gradation value Sb of the j-th raster line, that is, the command gradation value may be corrected up to a target command gradation value Sbt calculated by formula (3) as below by the use of a straight line approximation from a correspondence (Sa, Da) and (Sb, Db) between the command gradation value and the calculation density in the j-th raster line.

Sbt=Sb+(Sb−Sa)×{(Dbt−Db)/(Db−Da)} (3)

Moreover, the density correction value Hb for correcting the command gradation value Sb in regard to the j-th raster line is obtained by formula (2) mentioned above.

In this manner, the host computer 110 calculates the density correction value Hb of the command gradation value Sb for each raster line. Similarly, the host computer 110 calculates the density correction values Ha, Hc, Hd, and He of the command gradation values Sa, Sc, Sd, and Se for each raster line. Furthermore, the host computer 110 also calculates the density correction values Ha to He of each of the command gradation values Sa to Se for each raster line in regard to other ink colors.

After that, the host computer 110 transmits the data of the density correction value H to the printer 1, and stores the same in the memory 63 of the printer 1 (S025). As a consequence, in the memory 63 of the printer 1, a correction table (hereinafter, also called a BRS correction table) is written in which the density correction values Ha to He of each of five command gradation values Sa to Se for each raster line are collected.

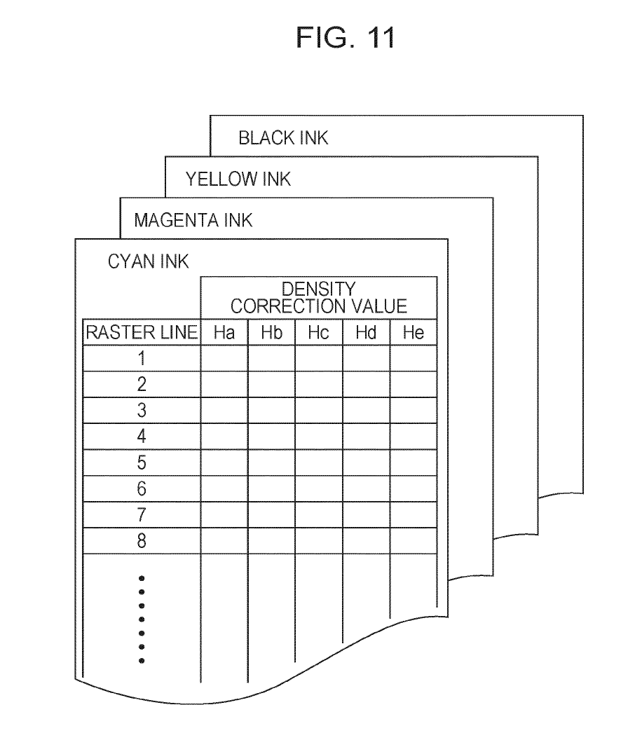

FIG. 11 is a diagram that shows a BRS correction table stored in the memory 63. By performing the correction value acquisition process mentioned above for each ink color, as shown in FIG. 11, the BRS correction table is written by the ink color. As a consequence, the BRS correction tables of each ink color are formed. The BRS correction table is referred by the printer driver so as to correct the gradation values of each raster line constituting the image data of the image when printing the image by the use of the printer 1.

Moreover, when executing the printing, the image of the density corrected by the density correction value H is printed.

For example, the printer driver of the host computer 110 corrects the gradation values of each pixel data (hereinafter, the gradation value before the correction is called Sin) based on the density correction value H of the raster line corresponding to the pixel data (hereinafter, the gradation value after the correction is called Sout).

Specifically, if the gradation value Sin of any raster line is equal to any one of the command gradation values Sa, Sb, Sc, Sd, and Se, it is possible to use the density correction value H stored in the memory of the host computer 110 as it is. For example, if the gradation value of the pixel data is Sin=Sb, the gradation value Sout after the correction is obtained by formula as below.

Sout=Sb×(1+Hb) (4)

Meanwhile, in a case where the gradation value of the pixel data is different from the command gradation values Sa, Sb, Sc, Sd, and Se, the correction value is calculated base on the interpolation using the density correction value of the command gradation value therearound. For example, in a case where the command gradation value Sin is between the command gradation value Sb and the command gradation value Sc, if a correction value obtained by the linear interpolation using the density correction value Hb of the command gradation value Sb and the density correction value Hc of the command gradation value Sc is set to H′, the gradation value Sout after correcting the command gradation value Sin is obtained by formula as below.

Sout=Sin×(1+H′) (4)′

In this way, the density correction process is performed for each raster line.

As mentioned above, the density irregularity can be reduced by correcting the density for each raster line.

However, in some cases, depending on the image (hereinafter, also referred to as a print target image) of the print target and the printing condition (used ink or the like) , it is difficult to completely suppress the density irregularity, and the streaky density irregularity is generated in a particular location. Thus, in the embodiments as below, the further reduction of the density irregularity is promoted. Hereinafter, in this manner, the process of correcting the density irregularity is called a density irregularity adjustment process.

### Density Irregularity Adjustment Process

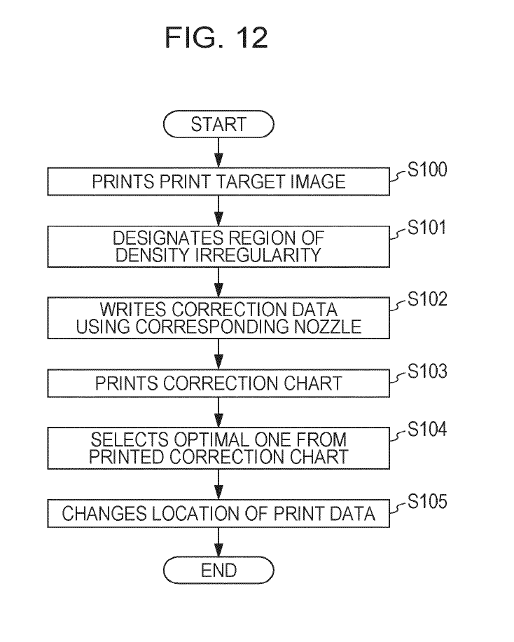

FIG. 12 is a diagram that shows a flow of the density irregularity adjustment process in the present embodiment.

Firstly, the host computer 110 transmits the print data of the image (hereinafter, also referred to as a print target image) becoming the print target to the printer 1. The printer 1 drives the head 31 based on the received print data as mentioned above, and discharges ink from the respective nozzles of the head 31. In this way, the print target image is printed in the print region R of the roll paper 2 (S100).

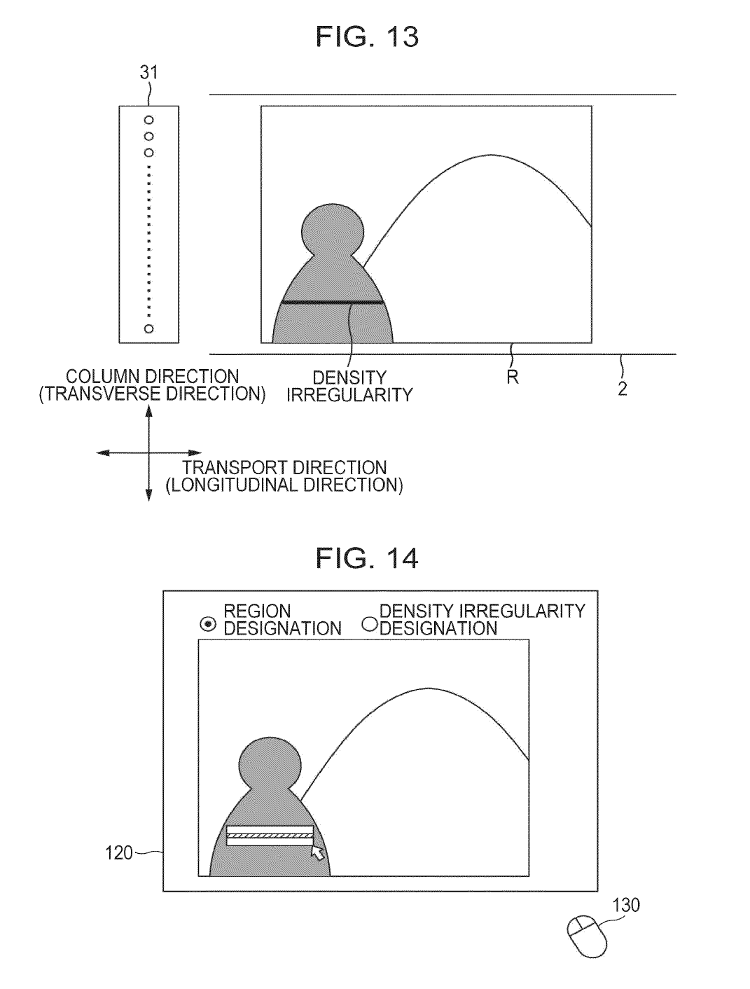

FIG. 13 is a diagram that shows an image printed in the print region R of the roll paper 2. In the present embodiment, as shown in FIG. 13, the density irregularity along the transport direction is generated in a part (a portion of gray in FIG. 13) of the image. In addition, in the present embodiment, for simplicity of explanation, the location of the density irregularity is formed in a single color (that is, formed by one nozzle row).

Next, the host computer 110 displays the screen for designating a region (hereinafter, also referred to as a density irregularity region) including the density irregularity in the display section 120 such as a display, and causes a user to designate the density irregularity region (FIG. 12, S101).

FIG. 14 is a diagram that shows an example of the designation screen of the density irregularity region. The print target image is displayed on the screen of the display section 120. A user compares the print target image with the image (FIG. 13) actually printed on the roll paper 2, and designates the location of the density irregularity and the region (hereinafter, also referred to as a density irregularity region) including the location on the screen of the display section 120, for example an input device 130 such as a mouse.

In the present embodiment, as shown in FIG. 14, it is possible to switch the designation of the density irregularity region and the designation of the location of the density irregularity, by the operation of the input device 130. In addition, in FIG. 14, a portion designated as the location of the density irregularity is indicated by an oblique line. Furthermore, the density irregularity region is indicated in a rectangular range surrounding the oblique line portion. When designating the density irregularity region, if the designation range of the density irregularity region is too small, it is difficult to know the presence or the absence of the density irregularity. On the contrary, if the designation range of the density irregularity region is too great, the number of the correction chart capable of being formed in the print region R becomes smaller. Thus, it is desirable to designate a suitable range. In addition, in the present embodiment, a user designates the density irregularity region, but the invention is not limited thereto. For example, upon designating the location of the density irregularity, a predetermined region (upper and lower 10 raster lines of the designation location of the density irregularity) including the designation location may automatically be set to the density irregularity region.

The host computer 110 creates the correction data of the density irregularity region based on information (the location and the area of the density irregularity) designated by a user (FIG. 12, S102).

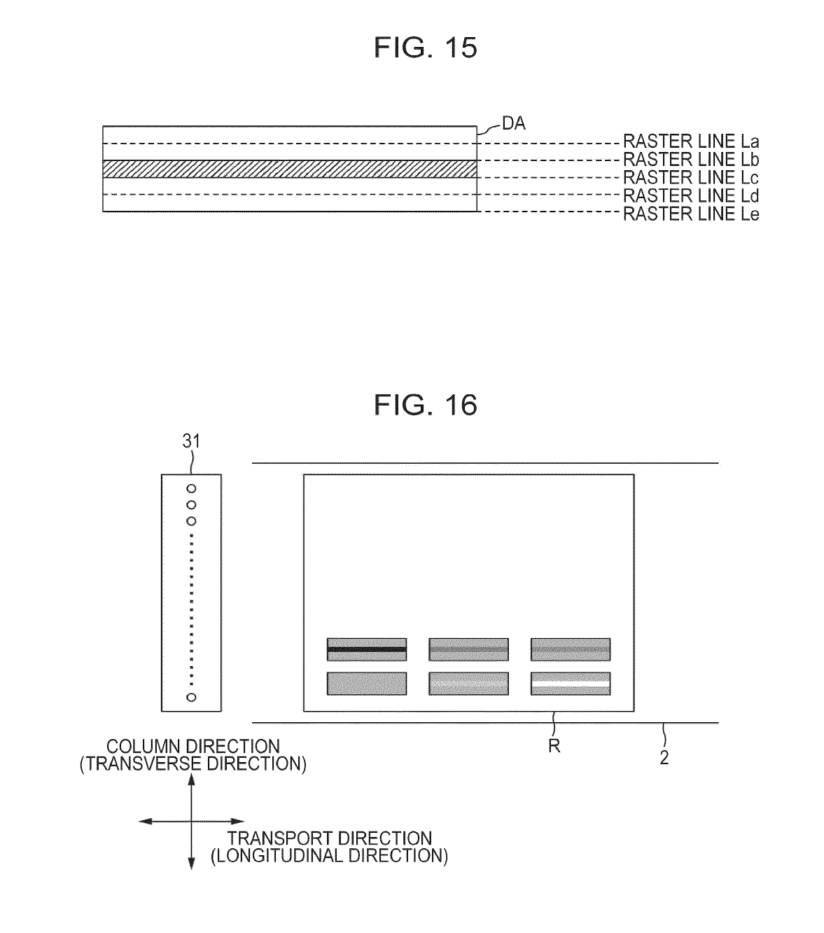

FIG. 15 is an explanatory diagram of the correction data. As shown in FIG. 15, the correction data DA is an image data corresponding to the region designated by a user. Herein, for simplicity of the explanation, the density irregularity region is constituted by five raster liens (La to Le), and the correction data DA is written which adjusts the density of one raster line (Lc: hereinafter, also referred to as a correction raster line) of them. In addition, as mentioned above, the respective raster lines correspond to the nozzles of the nozzle row of the head 31, respectively. Moreover, in the present embodiment, the nozzle (that is, a nozzle formed with the raster line Lc when printing the print target image) corresponding to the raster line Lc, which is the correction raster line, changes the discharging condition of ink when forming the raster line Lc.

If the correction data DA is generated by the use of the nozzle other than the nozzle corresponding to the raster line Lc in which the density irregularity is detected when printing the print target image, in the case of actually printing the print target image, an effect of the correction of the density irregularity is not reflected. On the contrary, in the present embodiment, the correction data DA is generated so as to necessarily use the nozzle corresponding to the raster line Lc in which the density irregularity is detected when forming the print target image. As a result, it is possible to perform the correction depending on the discharging characteristics of the nozzles, which can reliably suppress the density irregularity. Furthermore, as mentioned above, the density irregularity is also affected by the upper and lower raster lines. Thus, in the present embodiment, the raster lines of the region use the nozzles used when printing the print target image.

The host computer 110 creates a plurality of correction data items DA in which the gradation value is changed by the correction raster line Lc by the use of the nozzles each corresponding to five raster liens (La to Le) of the density irregularity region. The gradation value of the correction raster line Lc is, for example, to a value in which the entire gradation values (256 gradations) are equally divided by the number of the correction data, respectively. For example, in the case of forming eight patterns, the correction data for each (=256/8) is written.

Moreover, the host computer 110 transmits the print data with the written correction data DA placed side by side in the print region R of the roll paper 2 to the printer 1. Moreover, the printer 1 performs the printing of the correction chart in which a plurality of corrected images is placed in the print region R of the roll paper 2, based on the print data received from the host computer 110 (FIG. 12, S103).

FIG. 16 is a diagram that shows an example of the correction chart printed on the roll paper 2. In the printer 1 of the present embodiment, it is possible to form a plurality of patterns (the corrected image) in the transport direction by the use of the same nozzles of the head 31. However, the number of the pattern capable of being printed in the transport direction in the print region R is limited (three in the present embodiment). Thus, when it is difficult to print the pattern in the same position of the transport direction, the head 31 is moved in the row direction (for example, to the lower side of FIG. 16), and the printing of the continued pattern is performed again by the use of the same nozzles. In the present embodiment, six corrected images with different gradation values of the correction raster line Lc is printed in the print region R.

In addition, a distance, by which the head 31 is able to move in the row direction, is also limited (for example, about 10 cm). Thus, when it is difficult to form the corrected image in the print region R (a first page), the roll paper 2 may be intermittently transported in the transport direction, and the continued pattern may be printed in the next print region R (the next page). In this way, many corrected images can be printed regardless of the size of the density irregularity region.

Next, the host computer 110 displays the selection screen of the pattern of the correction chart on the display section 120, and causes a user to select an optimal pattern of the correction chart (FIG. 12, S104).

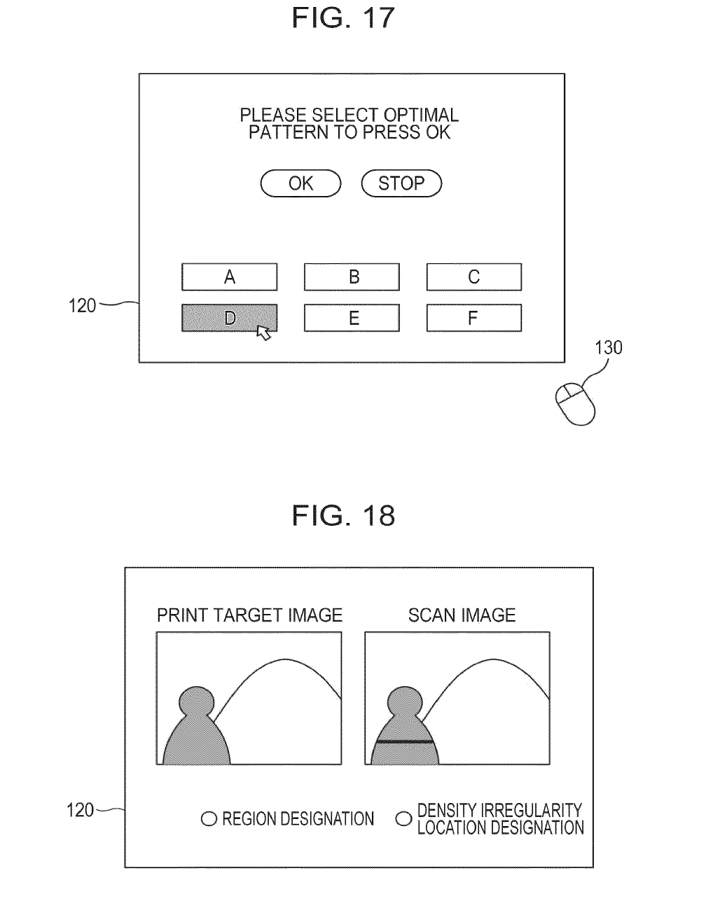

FIG. 17 is an explanatory diagram of an example of the selection screen. A user is able to select the patter of the smallest density irregularity of the correction chart printed on the roll paper 2 on the screen by the input device 130. For example, a pattern D is selected in FIG. 17.

When the pattern is selected, the host computer 110 changes the data of the density irregularity region of the print data of the print image to the data of the selected corrected image (FIG. 12, S105). Moreover, when printing the print target image on the roll paper 2, the host computer 110 causes the printer 1 to perform the printing, based on the print data by which the data of the portion of the density irregularity region is replaced.

As mentioned above, the printer 1 of the present embodiment forms the image by executing a pass of discharging liquid from each nozzle to the medium while moving the nozzle row, in which the nozzles are arranged in the row direction, in the transport direction, and a moving operation of moving the nozzle row between the passes in the row direction. In the images formed in the print region R of the roll paper 2, the input device 130 designates a region with the density irregularity by the operation of a user. The host computer 110 creates a plurality of correction data items DA in which the gradation value of the correction raster line Lc is changed, by the use of the nozzles corresponding to each raster line of the designated region, and prints the plurality of corrected images (the correction charts) based on the correction data DA by the printer 1. Moreover, the input device 130 selects the most suitable (that is, the density irregularity is small) corrected image of the printed correction chart by the operation of a user.

In this way, since a more correct correction can be performed on the density irregularity when actually printing the image on the roll paper 2, the density irregularity can more reliably be suppressed.

Furthermore, in the present embodiment, a plurality of corrected images is formed side by side in the transport direction intersecting the row direction. As a result, it is possible to form the plurality of corrected images by the same pass.

Furthermore, in the present embodiment, when it is unable to form the corrected image in the transport direction, the position of the head 31 in the row direction is changed, and the position in the row direction when arranging the corrected image in the transport direction is changed (that is, the image is also arranged in the row direction). In this way, it is possible to form the further corrected image in the same print region.

In addition, in the present embodiment, the corrected image is formed in one print region R (one page), but the plurality of corrected images may be formed over the plurality of print regions (multiple pages). In this way, the further corrected images can be formed regardless of the size of the density irregularity region.

### Modified Example of First Embodiment

In the embodiments mentioned above, a user designates the location and the region of the density irregularity via the input device 130, but, in a modified example, the host computer 110 designates of the location and the region of the density irregularity, and selects the pattern of the correction chart. That is, in the modified example, the host computer 110 corresponds to the designation section and the selection section.

In the modified example of the first embodiment, a scanner (corresponding to the reading section) (not shown), which reads the image printed on the roll paper 2, is included on the transport path of the downstream side from the print region R in the transport direction. The scanner reads the image printed on the print region R of the roll paper 2, and transmits the reading data to the host computer 110. The host computer 110 determines the present or the absence of the density irregularity from the reading data of the scanner. For example, a color difference AE between an average density of the image and density of the raster line is calculated for each raster line. When the color difference AE exceeds a threshold value (that is, when there is a density irregularity), like the embodiments mentioned above, the density irregularity region (for example, of upper and lower 10 raster lines thereof) is designated, and the correction data DA thereof is generated. In addition, since the generation of the correction data DA and the printing of the correction chart are the same as those of the embodiment mentioned above, the description thereof will be omitted.

Furthermore, the host computer 110 receives the reading data by the scanner of the correction chart, and selects the pattern having the smallest density irregularity of the correction chart. In this way, it is possible to simply and easily perform the designation of the density irregularity region and the selection of the optimal pattern of the correction chart.

### Second Embodiment

In a second embodiment, the image of the print target and the image printed on the roll paper 2 are simultaneously displayed, which makes it easy to designate the location of the density irregularity.

In addition, since a configuration of the printer 1, a configuration of the host computer 110, and an operation of the dot formation are the same as those of the first embodiment, the descriptions thereof will be omitted.

In the second embodiment, the same scanner (not shown) as that of the modified example of the first embodiment is provided at the downstream side in the transport direction than the print region R, and is able to automatically read the image printed on the roll paper 2. The scanner reads the image of the print region R of the roll paper 2 after being printed, and transmits the reading data to the host computer 110. The host computer 110 displays the print target image and the image read by the scanner on the display device 120 side by side.

FIG. 18 is an example that shows an example of the display screen of the display device 120 in the second embodiment.

As shown in FIG. 18, the print target image and the image, in which the image printed on the roll paper 2 is read by the scanner, are displayed on the screen of the display section 120. A left drawing of FIG. 18 is an image of the print target (the print target image), and a right drawing of FIG. 18 is a reading result (the scan image) of the image printed on the roll paper 2 by the scanner. Like FIG. 18, the density irregularity is generated in the actually printed image (the scan image).

A user is able to compare the print target image to the scan image on the screen of the display device 120, and thus, it is possible to simply and easily designate the location with the density irregularity and the region of the density irregularity.

In this manner, in the second embodiment, the print target image and the scan image are displayed on the display device 120 side by side. As a result, it is possible to easily perform the designation of the density irregularity region.

### Other Embodiments

The embodiments mentioned above mainly described the liquid ejecting apparatus, but the disclosure of the liquid discharging method is also included. Furthermore, the embodiments mentioned above are to facilitate the understanding of the invention, but are not intended to be construed as limiting the invention. It is needless to say that the invention is able to be modified and improved without departing from the gist thereof, and the equivalents thereof are included in the invention. Particularly, embodiments described below are also included in the invention.

### Liquid Discharging Apparatus

In the embodiments mentioned above, an ink jet printer as an example of the liquid discharging apparatus is described. However, the liquid discharging apparatus is not limited to the ink jet printer, but is also able to be embodied to a liquid discharging apparatus which discharges fluid (liquid, a fluidal body in which particles of a functional material are dispersed, and a flow-like body such as gel) other than ink. For example, the same technique as that of the embodiment mentioned above may be applied to, for example, various devices applying an ink jet technique such as a color filter manufacturing device, a dyeing device, a micromachining device, a semiconductor manufacturing device, a surface machining device, a three-dimensional modeling device, a gas vaporizing device, an organic EL manufacturing device (especially, a polymer EL manufacturing device), a display manufacturing device, a film forming device, and a DNA chip manufacturing device. Furthermore, such methods and the manufacturing methods are also a scope of the application range.

### Ink

Since the embodiments mentioned above was an embodiment of the printer, ink is discharged from the nozzles, but the ink may be a water-based ink and an oil-based ink. Furthermore, liquid discharged from the nozzles is not limited to ink. For example, liquid (also including water) including a metallic material, an organic material (especially, a polymer material), a magnetic material, a conductive material, a wiring material, a film forming material, an electronic ink, a working fluid, a gene solution or the like may be discharged from the nozzles.

### Discharging Method

In the embodiments mentioned above, ink was discharged by the use of the piezoelectric element. However, the method of discharging the liquid is not limited thereto. For example, other methods maybe used such as a method of generating bubbles in the nozzles by heat.

### Input Device

In the embodiments mentioned above, a mouse was used as the input device 130, but the input device is not limited thereto. For example, the input device may be a keyboard, and a touch panel. Furthermore, the designation of the density irregularity region and the selection of the corrected image may be performed by the respective different devices.

The entire disclosure of Japanese Patent Application No. 2011-65395, filed Mar. 24, 2011 is expressly incorporated by reference herein.

What is claimed is:

1. A liquid discharging apparatus comprising:
a dot forming section that forms a plurality of dot rows, in which dots are arranged in an intersection direction intersecting a row direction, in the row direction, by performing a discharging operation of discharging a liquid from each nozzle to a medium while moving a nozzle row, in which nozzles are arranged in the row direction, in the intersection direction, and a moving operation of moving of the nozzle row in the row direction during discharging operation;
a designation section that designates a density irregularity region having a density irregularity among the plurality of dot rows formed on the medium;
a correction data creating unit that creates a plurality of correction data items of the density irregularity region designated by the designation section, the correction data being obtained by changing a gradation value of a density irregularity portion of the density irregularity region, by the use of the nozzles each corresponding to each dot row of the density irregularity region; and
a selection section that selects a corrected image having a small density irregularity among a plurality of corrected images each formed on the medium by the dot forming section based on each correction data item.

2. The liquid discharging apparatus according to claim 1, wherein the dot forming section forms the plurality of corrected images side by side in the intersection direction.

3. The liquid discharging apparatus according to claim 2, wherein, when it is unable to form the plurality of corrected images side by side in the intersection direction, the dot forming section changes a position of the row direction when arranging the plurality of corrected images in the intersection direction, by moving the nozzle row in the row direction.

4. The liquid discharging apparatus according to claim 1, wherein the dot forming section forms the plurality of corrected images over multiple pages when being unable to be formed in one page.

5. The liquid discharging apparatus according to claim 1, further comprising:
a reading section that reads an image formed on the medium by the dot forming section,
wherein the designation section designates the density irregularity region based on a reading result of the reading section.

6. The liquid discharging apparatus according to claim 5, further comprising:
a display section that displays the reading result of the reading section of an image of a print target and the image printed on the medium side by side.

7. The liquid discharging apparatus according to claim 1, further comprising:
a reading section that reads an image formed on the medium by the dot forming section,
wherein the selection section selects a corrected image having a small density irregularity among the plurality of corrected images, based on the reading result of the reading section.
